(19) United States
(12) Patent Application Publication
(10) Pub. No.: US 2016/0224946 A1
(43) Pub. Date: Aug. 4, 2016

(54) SYSTEM AND METHOD FOR AUTOMATICALLY, IDENTIFYING, EXTRACTING AND MANAGING A LIST OF USER TASKS

(71) Applicant: ReQall Inc., Moffett Field, CA (US)

(72) Inventors: Sunil Vemuri, Santa Clara, CA (US); Yat Pan Ng, Singapore (SG); Steven Paul Ketchpel, Foster City, CA (US)

(21) Appl. No.: 14/611,099

(22) Filed: Jan. 30, 2015

(51) Int. Cl. G06Q 10/10; G06F 17/30

(52) U.S. Cl. CPC G06Q 10/1097; G06F 17/30557

(57) ABSTRACT

Exemplary embodiments of the present disclosure are directed towards a system and method for automatically identifying, extracting and managing a list of user tasks. The system includes a task identifier unit for identifying the sender, time of receiving the message and other metadata of the received messages. The system further includes a task identifier for identifying and extracting the tasks or actions associated with the received messages and generates tasks from them. A task collector unit of the system is configured to collect the list of tasks and store in a task list storage unit. The task prioritizing unit is configured to prioritize the identified and extracted list of tasks and define the priorities. The identified and extracted list of tasks may be provided over the user interface of the user device along with the required actions to be performed including reminder and notifications associated with the list of identified and extracted tasks.

### RELATED APPLICATIONS

This application claims priority to Singapore Application No. 201400742-1 filed Jan. 29, 2014 which is incorporated herein by reference

### TECHNICAL FIELD

The disclosed subject matter relates to a system and method for automatically identifying, extracting and managing a list of user tasks.

### BACKGROUND

Efficient scheduling of day to day tasks of a person is critical. Although making “to do” lists helps with task management, such lists are often outdated as soon as they are drafted. The frequent manual updating of such lists can be a substantial task itself Furthermore, frequently updated list of tasks can quickly become disorganized. Pocket calendars, appointment books and similar products can help with organization, but still require frequent, time-intensive, and manual updating.

Conventionally, few software programs allow maintenance of an electronic task list or calendar on a personal or handheld computer. Such systems are merely electronic versions of their paper predecessors. Although using an electronic task list or calendar allows for more efficient organization than the paper equivalent, these products do not help their users prioritize tasks, based on their urgency or other qualities, such as difficulty, importance, type, priority, deadline, required time to complete and completed percentage. Also the user may at times forget to add a task to the list, when there are multiple tasks to be added. Thus there may be a loss of attending an event or communicating back to the specified person and the like.

In the light of aforementioned discussion there exists a need of an efficient system and method for automatically identifying, extracting and managing a list of user tasks.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A more complete appreciation of the present disclosure and the scope thereof can be obtained from the accompanying drawings which are briefly summarized below and the following detailed description of the presently preferred embodiments.

Exemplary embodiments of the present disclosure are directed towards a system and method for automatically identifying, extracting and managing a list of user tasks. The method employed for identifying, extracting and managing the list of user tasks may be a data-communication-device-based approach, a server-unit-based approach or may be configured to operate between one or more data communication devices or on a client-server architecture wherein the client device may be any data communication device operated in a data communication network.

A preferred aspect of the present disclosure is to automatically identify the user events to attend and prepare a list of user tasks based on data fetched from the multiple communication modalities (mobile device, internet web service, external storage devices and wirelessly connected with host device) and/or electronic/mechanical devices (e. g., a device that can provide information through an application programming interface)

Another preferred aspect of the present disclosure is to display one or more attributes of each individual user task and the other people awaiting responses associated with each individual user task.

Another preferred aspect of the present disclosure is to describe a list of tasks that needs to be done by the user by eliminating manual input of the list of tasks by the user.

Another preferred aspect of the present disclosure is to automatically define priorities for the list of identified and extracted user tasks.

Further another preferred aspect of the present disclosure is also to fetch the location information of the each individual communication modality and/or electronic/mechanical devices by utilizing a pair of latitudes and longitudes of the specified geographical location and assign the latitude and longitude to the list of user tasks identified and extracted from individual communication modality and/or electronic/mechanical devices.

Further another preferred aspect of the present disclosure is to enable a user to manually define and associate latitude and longitude details to the identified and extracted list of user tasks for generating location based reminders to the user and sort the list of user tasks based on the location.

Further another preferred aspect of the present disclosure is to enable a user to automatically define and associate latitude and longitude details to the identified and extracted list of user tasks for generating location based reminders to the user and sort the list of user tasks based on the location.

Moreover, another preferred aspect of the present disclosure is to store the data corresponding to the list of identified and extracted list of user tasks in a local data repository unit or on cloud.

Still another preferred aspect of the present disclosure is to provide and notify the status of the list of tasks performed by the user.

Yet another preferred aspect of the present disclosure is to provide an expiry date and time for the identified and extracted list of user tasks.

### BRIEF DESCRIPTION OF DRAWINGS

Other objects and advantages of the present disclosure will become apparent to those skilled in the art upon reading the following detailed description of the preferred embodiments, in conjunction with the accompanying drawings, wherein like reference numerals have been used to designate like elements, and wherein:

FIG. 1 illustrates a system for automatically identifying, extracting and managing a list of user tasks, in accordance with one or more preferred embodiments.

FIG. 2 illustrates an exemplary diagram displaying status of user tasks on a user interface of a user device, in accordance with one or more preferred embodiments.

FIG. 3 illustrates an exemplary diagram displaying status details associated with the responses for list of user tasks on a user interface of a user device, in accordance with one or more preferred embodiments.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

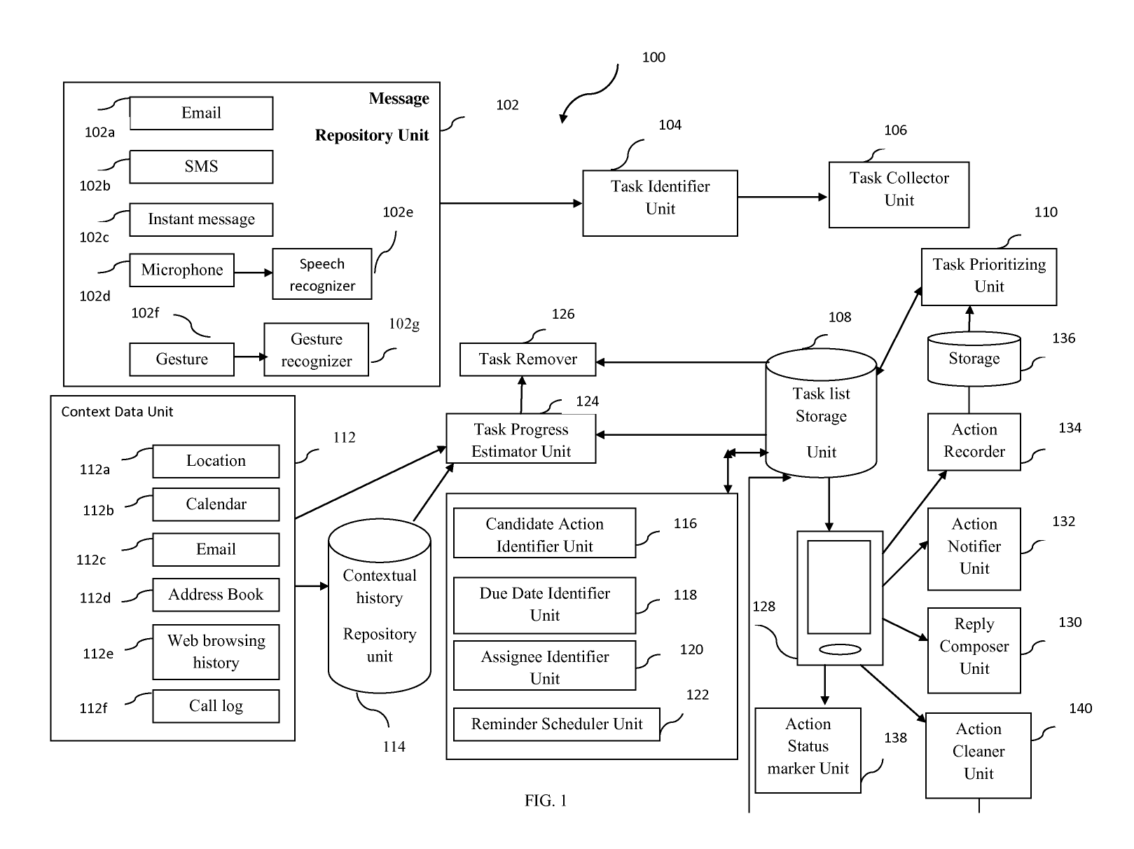

Referring to FIG. 1, a system 100 for automatically identifying, extracting and managing a list of user tasks is illustrated in which a message repository unit 102 comprises email 102a, SMS 102b, instant message 102c, a speech recognizer 102e for converting the audio data received through microphone 102d and a gesture recognizer 102g for identifying the gestures 102f. According to a preferred embodiment, the gesture recognizer 102g may include, but is not limited to, a visual gesture recognition system to recognize the gestures. According to one or more preferred embodiments, the message repository unit 102 may include data received from multiple senders, messages received from the user. The speech recognizer 102e may be configured to convert speech to text and the gesture recognizer 102g may be configured to identify the gestures.

According to one or more preferred embodiments, a task identifier unit 104 may be configured to identify and extract tasks or actions associated with the messages received from the message repository unit 102. The identifiers associated with the received messages may also include sender details, received time of the message and other metadata that enable the task identifier 104 to identify and extract distinct list of user tasks and qualities required for representation in the system.

According to one or more preferred embodiments, the system 100 may include a task collector unit 106 configured to collect and store the list of user tasks identified and extracted by the task identifier unit 104 and store in the data communication device of the user configured with the system 100. The list of user tasks identified and extracted by the task identifier unit 104 may be stored in a task list storage unit 108.

According to one or more preferred embodiments, the system 100 may include a task prioritizing unit 110 in communication with the task list storage unit 108 for prioritizing the list of identified and extracted tasks based on the sender, due date of the task, expiry date of the task, current location of the user, calendar actions, performed actions and historical priorities learned by the system 100. According to one or more preferred embodiments, the list of tasks generated and stored in the task list storage unit 108 are published on the user device 128 based on the priorities defined by the task prioritizing unit 110. The user interface of the user device 128 may be published with the list of identified and extracted tasks along with the candidate actions and notifications and reminders of the tasks.

According to one or more preferred embodiments, the system 100 may include a reply composer unit 130 for enabling the user to compose a reply to the identified and extracted task. The reply composer unit 130 may be configured to provide a customized messaging user interface (e.g., “Quick Reply” tab) along with a customized input layout (e.g. keyboard layout) based on the identified and extracted tasks.

According to one or more preferred embodiments, the system 100 may include an action notifier unit 132 to determine and identify if the person who assigned the task needs progress updates as the user completes the task. The system 100 may be configured to compose a message and deliver it to the assigner through email or sms or push notification. The message may contain active content such as a calendar invitation between the user and the assigner.

According to one or more preferred embodiments, the system 100 may include an action recorder unit 134 to automatically record actions performed by the user on the identified and extracted list of user tasks and store the recorded actions in a local repository unit 136 and update the task prioritizing unit 110.

According to one or more preferred embodiments, the system may further include an action status marker unit 138 configured to automatically mark the accomplished tasks as “completed” or “about to be completed” or “partially completed” etc.

According to one or more preferred embodiments, the system may further include an action cleaner unit 140 configured to automatically remove and/or archive the expired list of user tasks to the task storage unit 108.

According to one or more preferred embodiments, the system 100 may include a contextual data unit 112 comprising location information 112a, calendar information 112b, email information 112c, address book information 112d, web browsing history 112e and call log information 112f. The information or content of the context data unit 112 may be stored in a context history repository unit 114.

According to one or more preferred embodiments, the system 100 may further include a candidate identification unit 116 for identifying and offering candidate relevant actions to the user which may include but not limited to reply, add to calendar, call, snooze, etc.

According to one or more preferred embodiments, the system 100 may further include a due date identifier unit 118 for identifying the due date of the task listed in the message.

According to one or more preferred embodiments, the system 100 may further include an assignee identifier unit 120 for identifying and determining an assignee for the task, i.e. identifying to whom the task should be assigned.

According to one or more preferred embodiments, the system 100 may further include a reminder scheduler unit 122 configured to schedule when a reminder notification should be presented to the user based on the when the task was generated, the due date and the relevancy of the generated task.

According to one or more preferred embodiments, the system 100 may further include a task progress estimator unit 124 in communication with the context history repository unit 114, context data unit 112 and the task list storage unit 108. The task progress estimator unit 124 may be configured to retrieve the list of tasks stored in the task list storage unit 108 and, based on the observation and analysis of the context data unit, may be configured to estimate the progress of the list of identified and extracted tasks.

According to one or more preferred embodiments, the system 100 may further include a task remover unit 126 in communication with the task progress estimator unit 124 for removing the list of expired tasks from the task list storage unit 108.

In some preferred embodiments, the list of tasks may be related to the electronic/mechanical devices. For example, in case of electronic device such as refrigerator storing the grocery products may be configured with the sensors to detect the missing and/or depleted product from the refrigerator and automatically add the content of the list of awaiting responses. For example, in case of mechanical devices data such as a fuel level may be collected and transmitted to the data communication device.

Further, the generated list of user tasks may also be further associated with a plurality of attributes which may include but is not limited to Title, Sub-title, Body, Status, Location, Starting and ending date and time, Expiry date and time, Permanent, Type of platform, Possible completed condition, Reference identification and the like.

Also further as shown in FIG. 1, each task listed over the graphical user interface may have an expiry date and time for performing specified actions/tasks. If the task is once expired, it may not be visible to the user by default and it can either be archived automatically for later retrieval or alternatively it can also be deleted. Also, the expiry date and time may change based on the status of the tasks and the completed tasks may be archived immediately to avoid visual clutter. Furthermore each task may be provided with a specific domain name of the corresponding platform and/or device.

Moreover as shown in FIG. 1, for example if the awaiting task listed is extracted from incoming email, then the system automatically checks the emails of the corresponding user in outbox/sent box and cross references them with message IDs of the current incoming emails. In some embodiments, if the system finds that the user has responded to the corresponding emails, then the status of the corresponding task may be marked as completed. In some embodiments, if the system finds that the user has not responded to the corresponding emails, then the status of the corresponding task may be marked as pending. In some embodiments, if the system finds that the user has found that the task/action corresponding to the incoming email is performed up to a certain condition, then the status of the task may be marked as possibly-completed. Similarly, if the data communication device call log shows a return call, the task may be marked as complete.

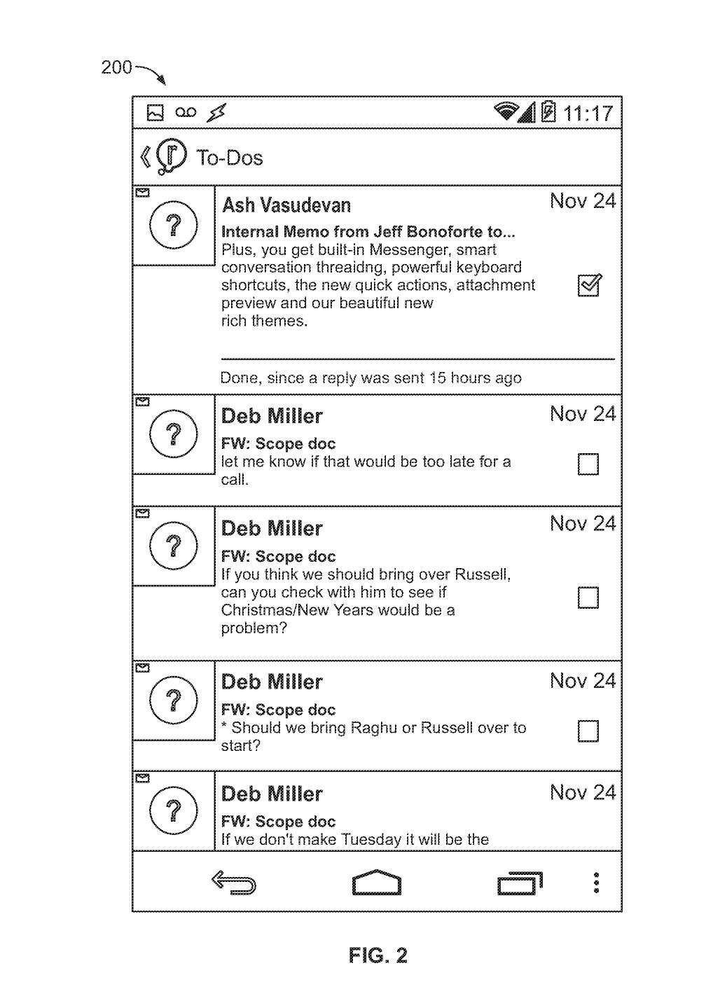

FIG. 2 is an exemplary diagram 200 displaying status of user tasks on a user interface of a user device. The user tasks may be related to the incoming mail, call log and events to be performed. For convenience the present disclosure displays only the incoming mail, call log and events. However it should be understood that in practice the user device may display data retrieved from multiple communication modalities and/or electronic/mechanical devices as similar as the awaiting responses of incoming mail, call logs and events to be performed. Therefore the present disclosure of user interface is not limited to incoming mails, call logs and events to be performed that may be included and/or supported by the system consistent with the disclosed embodiments.

As shown in FIG. 2, the task performed by the user may be automatically marked as completed in some preferred embodiments. In some other embodiment, the user can manually mark the completed task as completed. For example, FIG. 200 depicts user task of incoming mail as marked, whose status is determined as completed and the call log task is still found to be in the pending status, as the user has not responded to specific awaiting response. Thus the status of the tasks is determined based on the actions performed by the user.

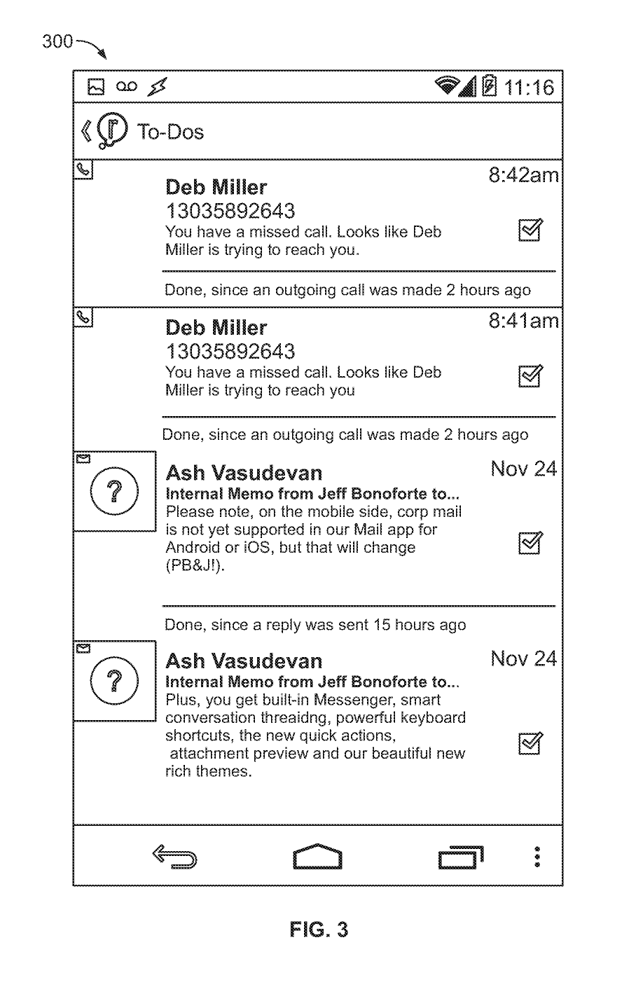

FIG. 3 is an exemplary diagram 300 displaying status details associated with the responses for list of user tasks on a user interface of a user device. According to a non limiting exemplary preferred embodiment of the present disclosure, the data displayed over the user interface of the user device is provided with the list of tasks requiring a response by the user.

As shown in FIG. 3, the tasks displayed are marked as completed, because the user has performed specified actions related to the corresponding task. For example, in the FIG. 2, the second task displayed is in pending status, which is related to the missed call. But the task displayed in FIG. 3 is displayed as the completed status. Similarly, all the tasks in pending status are found to be in completed status based on the actions performed by the user. Further, the completed status of the tasks may be expired based on the predetermined expiry date and time provided by the user.

While specific embodiments of the disclosure have been shown and described in detail to illustrate the inventive principles, it will be understood that the disclosure may be embodied otherwise without departing from such principles.

1. A method for automatically identifying, extracting and managing a list of user tasks, comprising: automatically identifying user events preparing a list of user tasks based on data fetched from multiple communication modalities and/or electronic/mechanical devices; displaying one or more attributes of each individual user task and other persons awaiting responses associated with each individual user task; fetching location information of the each individual communication modality and/or electronic/mechanical devices; automatically associating the location information with the list of user tasks for generating location based reminders for the user; and sorting the list of user tasks based on the location information.
